(19) United States
(12) Patent Application Publication
(10) Pub. No.: US 2015/0353756 A1
(43) Pub. Date: Dec. 10, 2015

(54) COATINGS FOR INDIUM-TIN OXIDE LAYERS

(71) Applicant: 3M INNOVATIVE PROPERTIES COMPANY, Saint Paul, MN (US)

(72) Inventors: Eileen M. Haus, St. Paul, MN (US); Mark J. Pellerite, Woodbury, MN (US); David B. Olson, Hudson, WI (US)

(21) Appl. No.: 14/654,973

(22) PCT Filed: Dec. 19, 2013
(86) PCT No.: PCT/US13/76326

§ 371 Date: Jun. 23, 2015

Related U.S. Application Data
(60) Provisional application No. 61/746,189, filed on Dec. 27, 2012.

(51) Int. Cl. C09D 133/08; G02F 1/1333

(52) U.S. Cl. CPC C09D 133/08; G02F 1/13338; G02F 1/133308; G02F 2001/133311

(57) ABSTRACT

Articles include a substrate surface with a layer of indium-tin oxide, and a cured resin layer of less than 25 micrometers thickness at least partially covering the indium-tin oxide layer. The cured resin layer is the cured product of a curable mixture including at least one acid-functional (meth)acrylate, and at least one initiator, and may include additional co-curable monomers and/or crosslinkers. Methods for preparing articles include providing a substrate with a layer of indium-tin oxide, providing a curable resin mixture, contacting the curable resin mixture to at least a portion of the layer of indium-tin oxide at a thickness of 1-25 micrometers; and curing the curable resin mixture. The curable resin mixture may be coated on the layer of indium-tin oxide, or it may be coated onto a processing substrate, and then laminated to the layer of indium-tin oxide.

### FIELD OF THE DISCLOSURE

This disclosure relates to coatings for surfaces that contain Indium-Tin Oxide (ITO) layers and articles that contain these coatings.

### BACKGROUND

Increasingly, articles that contain corrosion sensitive layers are being used in electronic devices. For example, recent trends include the combination of touch panel functions and various display applications. Touch panels typically include a corrosion sensitive layer, such as a layer of indium-tin oxide coated on a polyethylene terephthalate film or glass. These coated substrates are corrosion sensitive. Therefore, these layers are coated to protect the layer and often to carry out other functions.

A variety of curable coatings for metal surfaces or other related surfaces have been described. For example, US Patent Publication No. 2011/0024392 (Sato et al.) described an ink composition for ink jet printing which gives excellent adhesion to metal plates. The ink jet composition includes a polymerizable phosphoric ester compound or carboxy group containing monomer, a polyfunctional monomer with two or more ethylenic double bond groups, and a monofunctional monomer having an ethylenic double bond and no phosphoric ester group or carboxy group. US Patent Publication No. 2012/0228026 (Akutsu et al.) describes an anisotropic conductive film obtained by dispersing conductive particles in an insulating adhesive composition including a (meth)acrylate-based monomer composition, a radical polymerization initiator, and a film-forming resin. US Patent Publication No. 2012/0189779 (Hu) describes a photopolymerizable coating composition for polyamide substrates, wherein the photopolymerizable coating composition consists of at least one acid-functional monomer with a molecular weight of less than 240 g/m, at least one reactive crosslinking monomer and at least one photoinitiator.

### SUMMARY

Disclosed herein are articles that include a surface with a layer of indium-tin oxide and coatings of a cured resin layer, as well as methods for preparing such articles. Included is an article comprising a substrate surface comprising a layer of indium-tin oxide, and a cured resin layer at least partially covering the indium-tin oxide layer, the cured resin layer having a thickness of less than 25 micrometers. The cured resin layer comprises the cured product of a curable mixture comprising at least one acid-functional (meth)acrylate, and at least one initiator. The curable resin layer may also include additional co-curable monomers and/or crosslinkers.

Also disclosed are methods for preparing articles comprising providing a substrate with a layer of indium-tin oxide, providing a curable resin mixture, contacting the curable resin mixture to at least a portion of the layer of indium-tin oxide at a thickness of 1-25 micrometers; and curing the curable resin mixture. The curable resin mixture comprises at least one acid-functional (meth)acrylate, and at least one initiator. The curable resin layer may also include additional co-curable monomers and/or crosslinkers. In some embodiments, contacting the curable resin mixture to at least a portion of the layer of indium-tin oxide comprises coating the curable resin mixture. In other embodiments, contacting the curable resin mixture to at least a portion of the layer of indium-tin oxide comprises coating the curable resin mixture onto a processing substrate, and laminating the coated curable resin mixture to at least a portion of the layer of indium-tin oxide.

### DETAILED DESCRIPTION

The use of corrosion sensitive layers, such as indium-tin oxide, is increasing in the electronics industry. Tin-doped indium oxide, typically known as indium-tin oxide, is a widely used transparent conductive material, used in a wide range of electronic and display devices. Such materials can be sensitive to aggressive chemical reagents such as acids. Consequently, coatings are typically applied to these layers to protect them. It is generally desirable that these coatings do more than protect the corrosion sensitive layer. The demands on the coatings are thus fairly restrictive in that the coatings must adhere to the indium-tin oxide layer and also must not cause corrosion in the indium-tin oxide layers. Acid-functional materials are often useful in preparing coatings that adhere to metallic and metal oxide-based surfaces. However, because acidic materials tend to corrode layers such as indium-tin oxide, they are generally avoided in the preparation of coatings for these layers.

In addition to adhering to the indium-tin oxide layer and not corroding the indium-tin oxide layer, it is desirable that the coating have additional features in, for example, cholesteric liquid crystal devices. It is desirable for the coatings to be relatively thin and also to have a microstructured surface. The microstructured surface can be used as a template to hold the cholesteric liquid crystals. Relative thinness is desirable to reduce the voltage required by the device.

Described herein are cured coatings for corrosion sensitive layers such as indium-tin oxide. These coatings are prepared from acid-functional monomers and yet do not corrode the indium-tin oxide layers. For example, as shown in the Examples section, an electronic device prepared with the coatings of this disclosure still functioned even after 119 weeks of room temperature storage. Additionally, the coatings adhere strongly to the indium-tin oxide layer and are capable of having a microreplicated pattern imparted onto the exposed surface. Additionally, the coatings are relatively thin.

Unless otherwise indicated, all numbers expressing feature sizes, amounts, and physical properties used in the specification and claims are to be understood as being modified in all instances by the term “about” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

As used herein, the term “microreplicated surface” refers to a surface to which a microstructured pattern has been imparted.

As used herein, the terms “microstructure” and “microstructured pattern” means a configuration of features wherein at least 2 dimensions of the features are microscopic. The topical and/or cross-sectional view of the features must be microscopic.

As used herein, the term “microscopic” refers to features of small enough dimension so as to require an optic aid to the naked eye when viewed from any plane of view to determine its shape. One criterion is found in Modern Optic Engineering by W. J. Smith, McGraw-Hill, 1966, pages 104-105 whereby visual acuity, “ . . . is defined and measured in terms of the angular size of the smallest character that can be recognized.” Normal visual acuity is considered to be when the smallest recognizable letter subtends an angular height of 5 minutes of arc on the retina. At typical working distance of 250 mm (10 inches), this yields a lateral dimension of 0.36 mm (0.0145 inch) for this object.

The term “(meth)acrylate” refers to monomeric acrylic or methacrylic esters of alcohols. Acrylate and methacrylate monomers or oligomers are referred to collectively herein as “(meth)acrylates”. Polymers described as “(meth)acrylate-based” are polymers or copolymers prepared primarily (greater than 50% by weight) from (meth)acrylate monomers and may include additional ethylenically unsaturated monomers.

Unless otherwise indicated, “optically transparent” refers to an article, film or adhesive composition that has a high light transmittance over at least a portion of the visible light spectrum (about 400 to about 700 nm).

Unless otherwise indicated, “optically clear” refers to an adhesive or article that has a high light transmittance over at least a portion of the visible light spectrum (about 400 to about 700 nm), and that exhibits low haze.

The term “wavelength of visible light” as used herein encompasses the wavelengths of the light spectrum that constitutes visible light (about 400 to about 700 nm).

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The terms “free radically polymerizable” and “ethylenically unsaturated” are used interchangeably and refer to a reactive group which contains a carbon-carbon double bond which is able to be polymerized via a free radical polymerization mechanism.

Disclosed herein are articles comprising a substrate surface comprising a layer of indium-tin oxide and a cured resin layer at least partially covering the indium-tin oxide layer. The cured resin layer has a thickness of typically less than 25 micrometers, and is the cured product of a curable mixture. The curable mixture comprises at least one acid-functional (meth)acrylate and at least one initiator. The curable mixture may also contain a variety of additional free radically polymerizable components.

A wide variety of substrate surfaces with a layer of indium-tin oxide are suitable for the articles of this disclosure. The substrate surfaces may be rigid, semi-rigid, or flexible. Examples of rigid and semi-rigid substrates include a wide variety of glass substrates and polymeric substrates such as polymethylmethacrylate (PMMA) and polycarbonate (PC). Examples of flexible substrates include a wide range of films. The films can be monolayer films or multi-layer films. The films can be prepared from a wide range of materials. Examples of suitable films include polyolefin films, poly(meth)acrylate films, polyester films, polystyrene films, polycarbonate films, vinyl films, cellulose-based films, and blend films. Polyester films, especially poly ethylene terephthalate films are particularly suitable.

The indium-tin oxide layer can be continuous or discontinuous. Typically, the indium-tin oxide layer comprises an electro-conductive trace. In many embodiments, the electro-conductive trace is in the form of lines or, more typically, a grid.

The articles of this disclosure also comprise a cured resin layer. This cured resin is prepared by curing a curable mixture. The curable mixture comprises at least one acid-functional (meth)acrylate and at least one initiator. The curable mixture may also contain a variety of additional free radically polymerizable components. Each of these components will be described in detail below.

In some embodiments, it may be desirable that the cured resin layer have a microstructured surface on its exterior surface. This microstructured surface can be imparted to the cured resin layer by casting the curable mixture onto a microstructured tool. A microstructured tool is a tool that has a surface that has a microreplicated pattern. Examples of microstructured tools include microstructured release liners and micromachined metal tools. Examples of suitable tools include those made from nickel, nickel-plated copper, or brass as described, for example, in U.S. Pat. No. 5,175,030 (Lu et al.) and U.S. Pat. No. 5,183,597 (Lu).

After casting the curable mixture onto the microstructured tool, the curable mixture is cured. The cured resin layer will thus have a microreplicated surface pattern that is the negative of the microreplicated surface pattern of the microstructured tool. For example, if the tool surface has a concavity, this will create a convexity on the cured resin layer surface. Similarly, if the tool surface has a convexity, it will create a concavity on the cured resin layer surface.

The microstructured surface of the cured resin mixture generally comprises a plurality of parallel longitudinal ridges extending along a length or width of the cured resin surface. These ridges can be formed from a plurality of prism apexes. Each prism has a first facet and a second facet. The prisms are formed on a base that has a first surface on which the prisms are formed and a second surface that is substantially flat or planar and opposite the first surface. By right prisms it is meant that the apex angle is typically about 90°. However, this angle can range from 70° to 120° and may range from 80° to 100°. These apexes can be sharp, rounded or flattened or truncated. For example, the ridges can be rounded to a radius in a range of 4 to 7 to 15 micrometers. The spacing between prism peaks (or pitch) can be 5 to 300 micrometers. The prisms can be arranged in various patterns such as described in, for example, U.S. Pat. No. 7,074,463.

In some embodiments, it may desirable that the cured resin layer be optically transparent or optically clear. Optically transparent cured resin layers have a high light transmittance over at least a portion of the visible light spectrum (about 400 to about 700 nm). Optically clear cured resin layers have a high light transmittance over at least a portion of the visible light spectrum (about 400 to about 700 nm), and exhibit low haze. Optically clear compositions generally have visible light transmission of greater than 90%, and a haze of less than 5%. In some embodiments, the optically clear compositions may have a visible light transmission of greater than 95% and/or a haze value of less than 2%. Visible light transmission and haze can be measured using well understood optical techniques. For example, visible light transmission and haze can be measured with a BYK Gardner Spectrophotometer using the techniques described in the test method ASTM D1003.

In some embodiments, the cured resin layer is relatively thin, having a thickness of less than 25 micrometers. In some embodiments the cured resin layer has a thickness of from 1-25 micrometers, or 2-20 micrometers, or even 5-12 micrometers.

As mentioned above, the use of acid-functional materials in coatings that contact indium-tin oxide layers can cause corrosion. Therefore, it is quite surprising that suitable acid-functional (meth)acrylates have been utilized to give cured coatings which do not corrode indium-tin oxide layers. Examples of acrylate-functional monomers suitable for use in the coatings of this disclosure are shown in Formula 1 and Formula 2 below.

Formula 1 has the general structure:

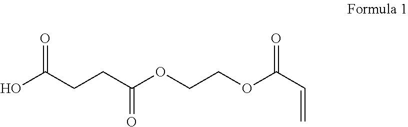

While Formula 1 shows an acrylate-functional monomer, the meth-acrylate monomer may also be suitable.

Formula 2 has the general structure:

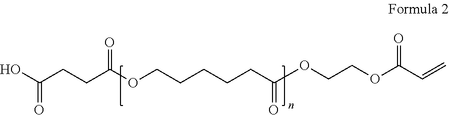

In Formula 2, n is an integer of 2 or 3. While Formula 2 shows an acrylate-functional monomer, the meth-acrylate monomer may also be suitable.

A wide range of free-radical initiators are suitable. While both thermal initiators and photoinitiators are contemplated, for ease of processing typically photoinitiators are used. Useful photoinitiators include substituted acetophenones such as benzyl dimethyl ketal and 1-hydroxycyclohexyl phenyl ketone, substituted alpha-ketols such as 2-methyl-2-hydroxypropiophenone, benzoin ethers such as benzoin methyl ether, benzoin isopropyl ether, substituted benzoin ethers such as anisoin methyl ether, aromatic sulfonyl chlorides, and photoactive oximes.

Particularly suitable photoinitiators are those available under the trade designations IRGACURE and DAROCUR from Ciba Speciality Chemical Corp., Tarrytown, N.Y. and include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxyl)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173). Also particularly suitable are “LUCERIN TPO” (2,4,6-trimethylbenzoylphosphine oxide) and “LUCERIN TPO-L” (ethyl-2,4,6-trimethylbenzoylphenyl phosphinate), both commercially available from BASF Corp., Florham Park, N.J. Particularly desirable photoinitiators are IRGACURE 819, 651, 184, and 2959, and LUCERIN TPO.

The photoinitiator may be used in an amount from about 0.001 to about 5.0 parts by weight per 100 parts of total monomer, more typically from about 0.01 to about 5.0 parts by weight per 100 parts of total monomer, and even more typically in an amount from 0.1 to 0.5 parts by weight per 100 parts of total monomer.

The curable mixture may contain one or more additional free radically polymerizable monomers. A wide range of copolymerizable monomers are suitable. Among the suitable copolymerizable monomers are urethane acrylate monomers, epoxy acrylate monomers, difunctional (meth)acrylate monomers, trifunctional (meth)acrylate monomers, and a variety of free radically polymerizable monomers. These monomers may be used alone or in combinations with each other. Each of these classes of materials will be described in greater detail below.

A wide range of urethane acrylate monomers are suitable for use as comonomers for the coatings of this disclosure. Suitable urethane acrylate monomers are commercially available as difunctional monomers or higher functional monomers from suppliers such as Cognis Corp., Cincinnati, Ohio, Shin-Nakumaru Chemical Co., Wakayama, Japan, and Sartomer USA, Exton, Pa. A particularly useful urethane acrylate monomer is available as PHOTOMER 6010 from Cognis Corp. of Cincinnati, Ohio.

A wide range of epoxy acrylate monomers are suitable comonomers. Suitable epoxy acrylate monomers are commercially available as difunctional monomers or higher functional monomers from suppliers such as BASF Corp., Florham Park, N.J., Cognis Corp., Cincinnati, Ohio, and Sartomer USA, Exton, Pa. A particularly useful epoxy acrylate monomer is available as CN 120 from Sartomer USA, Exton, Pa.

A wide range of difunctional (meth)acrylate and trifunctional (meth)acrylate monomers are suitable. These compounds are commonly used as crosslinking agents in the (meth)acrylate art. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, and polypropylene glycol di(meth)acrylates. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate.

Examples of other free radical polymerizable monomers include alkyl (meth)acrylate monomers such as those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl acrylate, and mixtures thereof. Other free radical polymerizable monomers include vinyl monomers such as vinyl esters (e.g. vinyl acetate), styrene and substituted styrenes, and the like.

Some particularly suitable curable mixtures comprise 20-50% by weight of urethane-based (meth)acrylate, epoxy-based (meth)acrylate or combination thereof, 10-30% by weight of acid-functional (meth)acrylate, 10-30% by weight of difunctional (meth)acrylate, 5-15% by weight of trifunctional (meth)acrylate, and 0.1-1.0% by weight of initiator.

Also disclosed herein are methods for preparing articles comprising, providing a substrate with a layer of indium-tin oxide, providing a curable resin mixture, contacting the curable resin mixture to at least a portion of the layer of indium-tin oxide, and curing the curable resin mixture.

Suitable substrates with a layer of indium-tin oxide have been described above. As mentioned above, typically the layer of indium-tin oxide is a discontinuous layer in the form or lines or a grid.

Suitable curable resin mixtures have been described above. The curable resin mixture can be contacted to the layer of indium-tin oxide either by directly coating the curable resin mixture onto the layer of indium-tin oxide, or the curable resin mixture can be coated onto a processing substrate and laminated to the layer of indium-tin oxide. Examples of suitable processing substrates include, for example, release liners, including microstructured release liners, and microstructured or flat tools. While it may be desirable for the curable resin mixture to contact only the layer of indium-tin oxide, more typically, the curable resin mixture is also contacted to portions of the substrate surface that do not have a layer of indium-tin oxide. In some embodiments, it may be desirable for the curable resin mixture to contact the majority or even all of the substrate surface.

Typically, it is desirable that the curable resin mixture is present as a relatively thin layer. Typically the curable resin mixture layer has a thickness of 1-25 micrometers.

After contacting the layer of indium-tin oxide, the curable resin mixture is cured. This curing is effected by activating the initiator present in the curable resin mixture, to initiate free radical polymerization. Typically, the initiator is a photoinitiator and curing is effected by exposing the curable resin mixture to, for example, ultraviolet radiation. The radiation used should be of a wavelength and intensity to activate the photoinitiator. Upon curing, the processing substrate, if used can be removed.

### EXAMPLES

Resin samples with acid functionality were made and tested showing adhesion to ITO surfaces. A resin with acid functionality was also microreplicated onto ITO. These examples are merely for illustrative purposes only and are not meant to be limiting on the scope of the appended claims. All parts, percentages, ratios, etc. in the examples and the rest of the specification are by weight, unless noted otherwise.

### Materials:

| Abbreviation | Description |
|---|---|
| ITO Film | ITO coated PET film SP-5013-100-5, commercially |
| | available from Materion Corp. (formally Techni-Met), |
| | Windsor, CT. |
| O1 | Oligomer, urethane acrylate, commercially available |
| | from BASF Monheim, Germany as “P6010” |
| M1 | Monomer, mono-2-(Acryloyloxy)ethyl succinate #454966 |
| | commercially available from Sigma-Aldrich, Inc., |
| | St. Louis, MO |
| M2 | Monomer, trimethylolpropane triacrylate, commercially |
| | available from Sartomer Company, Warrington, PA |
| | as “SR-351” |
| M3 | Monomer, 1,6-hexanediol diacrylate, commercially |
| | available from Sartomer Company, Warrington, PA |
| | as “SR238B” |
| M4 | Monomer, succinate anhydride dicaprolactone acylate |
| | as described in U.S. Pat. No. 8,282,863 (Jones) |
| M5 | Monomer, triethylene glycol diacrylate, commercially |
| | available from Sartomer Company, Warrington, PA |
| | as “SR-272” |
| PI | Photoinitiator, 2,4,6-trimethylbenzoyldiphenylphosphine |
| | oxide commercially available from BASF Corp., Florham |
| | Park, NJ as “LUCERIN TPO”. |
| O2 | Oligomer epoxy acrylate, commercially available from |
| | Sartomer Company, Warrington, PA as “CN120” |
| R1 | Polymerizable resin composition, bisphenol A epoxy |
| | diacrylate, trimethylol propane triacrylate, 1,6 hexanediol |
| | diacrylate, dimethylaminoethyl acrylate (25/38/25/12) |
| | and photoinitiator as described in example 14 in |
| | U.S. Pat. No. 7,862,187 (Thakkar) |
| R2 | Polymerizable resin composition, aliphatic urethane- |
| | acrylate oligomer, hexanediol diacrylate (75/25) and |
| | photoinitiator as described in U.S. Pat. No. 6,811,841 |
| | (Castiglione) |

FORMULATION TABLE

| Formulation | Components (parts by weight) |
|---|---|
| F1 | O2/M1/M2 (60/20/20) + 0.5 PI |
| F2 | O2/M2/M4 (60/20/20) + 0.5PI |
| F3 | O1/M1/M2 (60/20/20) + 0.5PI |
| F4 | O1/M1/M2/M3 (30/20/10/40) + 0.5PI |
| F5 | O1/M1/M2/M5 (40/20/20/20) + 0.5PI |
| F6 | O1/M1/M2/M5 (40/20/10/40) + 0.5PI |
| F7 | O1/M1/M2/M3 (37.5/20/12.5/30) + 0.5PI |

### Test Methods

### Adhesion Test Methods

Tape Test 1: SCOTCH MAGIC 810 tape (2.5 cm wide 5 cm long) from 3M Company, St. Paul, Minn. was applied to the coated surface using a 5 cm roller then pulled away at a 90° angle. The rating was pass/fail, with pass being 100% adhesion of the coating to the ITO substrate.
Tape Test 2: Adhesion was also measured according to ASTM D 3359, a crosshatch tape pull test using SCOTCH PREMIUM CELLOPHANE 610 tape from 3M Company, St. Paul, Minn. Ratings were on a scale of 0-5 with 5 being good adhesion (no resin layer removal) and 0 being complete delamination.

### Viscosity

The samples were investigated using a Stress-Controlled Rheometer, model AR-G2, from TA Instruments (159 Lukens Drive, New Castle, Del. 19720). Each sample was subjected to a temperature ramp from 25° C. to 85° C. over a period of 20 mins while maintaining a constant shear rate of 1 s⁻¹. Data collected was viscosity in centipoise (cps) as a function of temperature (° C.) and is hereby reported.

### EXAMPLES

### Resin Preparation

Using the components in the Formulation Table, the resin compositions were prepared. They were mixed while being heated to 50° C. Viscosity measurements were made on the resin compositions using the test method described above. Results are recorded in Table 1.

### Examples 1-8 and Comparative Examples C1 and C2

Resin compositions were coated onto ITO Film using the formulations and conditions in Table 1. The resin composition was first heated to 80° C. in an oven for approximately 60 minutes. The following materials were sandwiched and feed into a laminator (PL-1200hp from Professional laminating Systems, Inc, Hamilton, Mont.):
Top—PET film (127 micrometers thick 618 MELINEX film available from DuPont Teijin Films, Chester, Va.)
ITO Film with ITO side down
1 milliliter of Resin composition
Tool (2 tools were used):
   Flat—Flat stainless steel plate 165 mm wide, 254 mm long and 1 mm thick (Stock mill finish, Stainless Steel Sales Minneapolis, Minn.)
   Micro—Microrib tool 13.5 cm×31 cm×1 mm thick steel plate with 15 micrometer high×35 micrometer wide ribs 270 micrometers apart.
Bottom—PET film (127 micrometers thick 618 MELINEX film available from DuPont Teijin Films, Chester, Va.)

The laminator temperature was set to 82° C. The speed was approximately 0.3 m/min. After lamination the samples were passed through a UV curing station (LIGHT HAMMER 6 Fusion UV Systems, Inc., Gaithersburg, Md.) 2 times at a speed of 3.2 in/min using a “D” bulb at 100% power. The Resin/ITO Film sample was then pulled from the tool. The Resin thickness was measured and ranged from 5 to 12 micrometers. The Resin/ITO Film samples were then tested for adhesion using the test methods described above. Results are recorded in Table 1.

TABLE 1
Adhesion data for Examples 1-8

| | Resin | | Viscosity | | |
|---|---|---|---|---|---|
| | Formu- | | (cps) at | Adhesion | Adhesion |
| Example# | lation# | Tool | 80° C. | Test 1 | Test 2 |
| E1 | F1 | Flat | 86.6 | Pass | 0 |
| E2 | F2 | Flat | 181.1 | Pass | 0 |
| E3 | F3 | Flat | 403.5 | Pass | 0 |
| E4 | F4 | Flat | 44.4 | Fail | 0-1 |
| E5 | F5 | Flat | 136.4 | Pass | 5 |
| E6 | F6 | Flat | 56.9 | Pass | 5 |
| E7 | F7 | Flat | 17.2 | Pass | 5 |
| E8 | F7 | Micro | 17.2 | N/A | N/A |
| Comparative | R1 | Flat | 6.8 | Fail | 0 |
| Example C1 | | | | | |
| Comparative | R2 | Flat | 53 | Fail | 0 |
| Example C2 | | | | | |

### Example 9

A Cholesteric Liquid Crystal Display (ChLCD) was constructed and tested for switching functionality. Substrates were obtained from 3M Touch Systems (3M Company in Tucson, Ariz.). The substrates for the device were 13.5-inch×13.5-inch (34.3 cm×34.3 cm) three-dpi ITO coated PET with 100 Ohms/square conductivity.

Following the process described in Examples 1-8, Resin F7 was heated to 85° C., coated onto one of the substrates using the Microrib tool that was also heated to 85° C., and fed into the laminator. The resin was cured with 2 passes through the curing unit. A cholesteric liquid crystal solution was laminated between the resin coated substrate and another uncoated substrate. The substrates were aligned at right angles to each other with the ITO surfaces facing inward. The cholesteric liquid crystal formulation comprised 83.5% MDA-01-1955 licristal (Merck, EMD Chemicals, Gillstown, N.J.), 14.6% MDA-00-3506 licristal (Merck, EMD Chemicals, Gillstown, N.J.), 1.9% Sekisui 3-micrometer diameter SP-203 Micropearl SP/EX Polymer microsphere beads, (Sekisui Products, Troy, Mich.). The cholesteric liquid crystal was then cured in a UV curing unit at 1.4 mW/cm² for 10 minutes.

### Testing and Results

LCD switching equipment consisted of an Agilent Technologies (Santa Clara, Calif.) MSO6014A Mixed Signal Oscilloscope, Sony Tektronix (Tokyo, Japan) AFG320 Arbitrary Function Generator, and Kepco (Flushing, N.Y.) Bypolar Operational Power Supply/Amplifier Model BOP 100-1M. The sample was connected to the switching equipment using alligator clips. The sample switched at 80 volts. The sample was stored at ambient temperature, and 119 weeks later the sample was retested for switching and switched at 80 volts.

What is claimed is:

1. An article comprising:
a substrate surface comprising a layer of indium-tin oxide; and
a cured resin layer at least partially covering the indium-tin oxide layer, the cured resin layer having a thickness of less than 25 micrometers and comprising the cured product of a curable mixture comprising:
at least one acid-functional (meth)acrylate; and
at least one initiator.

2. The article of claim 1, wherein the curable mixture further comprises at least one additional (meth)acrylate.

3. The article of claim 1, wherein the curable mixture further comprises at least one urethane-based (meth)acrylate, at least one epoxy-based (meth)acrylate, or a combination thereof.

4. The article of claim 1, wherein the curable mixture further comprises at least one crosslinker.

5. The article of claim 4, wherein the crosslinker comprises a difunctional (meth)acrylate, a trifunctional (meth)acrylate, or a combination thereof.

6. The article of claim 1, wherein the curable mixture comprises 10-30% by weight of acid-functional (meth)acrylate.

7. The article of claim 1, wherein the acid functional (meth)acrylate comprises the compound of Formula 1:

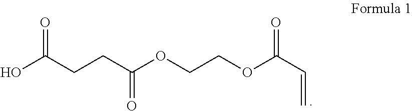

8. The article of claim 1, wherein the acid functional methacrylate comprises the compound of Formula 2: 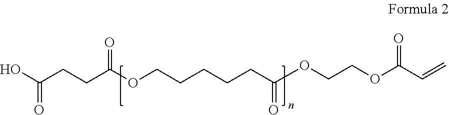
wherein, n is an integer of 2 or 3.

9. The article of claim 1, wherein the cured resin layer has a microstructured surface.

10. The article of claim 1, wherein the cured resin layer is optically clear.

11. A method for preparing an article comprising:
providing a substrate wherein at least one surface of the substrate comprises a layer of indium-tin oxide;
providing a curable resin mixture comprising:
at least one acid-functional (meth)acrylate; and
at least one initiator;
contacting the curable resin mixture to at least a portion of the layer of indium-tin oxide at a thickness of 1-25 micrometers; and
curing the curable resin mixture.

12. The method of claim 11, wherein contacting the curable resin mixture to at least a portion of the layer of indium-tin oxide comprises coating the curable resin mixture.

13. The method of claim 11, wherein contacting the curable resin mixture to at least a portion of the layer of indium-tin oxide comprises:
coating the curable resin mixture onto a processing substrate; and
laminating the coated curable resin mixture to at least a portion of the layer of indium-tin oxide.

14. The method of claim 13, wherein the processing substrate comprises a release liner, a microstructured release liner, a flat tool, or a microstructured tool.

15. The method of claim 11, wherein curing comprises exposure to ultraviolet radiation.

16. The method of claim 11, wherein the curable mixture further comprises at least one additional (meth)acrylate.

17. The method of claim 11, wherein the curable mixture further comprises at least one urethane-based (meth)acrylate or epoxy-based (meth)acrylate.

18. The method of claim 11, wherein the curable mixture further comprises at least one crosslinker.

19. The method of claim 11, wherein the acid functional (meth)acrylate comprises the compound of Formula 1:

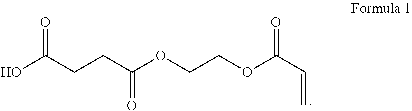

20. The method of claim 11, wherein the acid functional methacrylate comprises the compound of Formula 2: 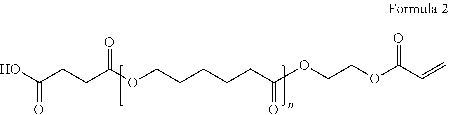
wherein, n is an integer of 2 or 3.
